(19) United States
(12) Patent Application Publication
(10) Pub. No.: US 2026/0352255 A1
(43) Pub. Date: Nov. 5, 2026

(54) INTERFERENCE MITIGATION IN SUPER-QAM MODULATIONS

(71) Applicant: QUALCOMM Incorporated, San Diego, CA (US)

(72) Inventors: Aviv REGEV, Tel Aviv (IL); Ronen SHAKED, Kfar Saba (IL); Amit MOSES, Givatayim (IL)

(21) Appl. No.: 19/196,446

(22) Filed: May 1, 2025

(51) Int. Cl. H04B 1/68; H04B 17/309; H04L 5/00

(52) U.S. Cl. CPC H04B 1/68; H04B 17/309; H04L 5/0092

(57) ABSTRACT

A method for wireless communication at a first user equipment (UE) and related apparatus are provided. In the method, the first UE transmits to a network entity first information for a frequency dependent residual side band (FDRSB) estimation and correction on the first UE. The first UE then receives, from the network entity based on the first information, second information for a pilot signal of a second UE. The first UE is frequency domain multiplexed (FDMed) with the second UE, and the first frequency band of the first UE partially overlaps with a mirror frequency band of a second frequency band of the second UE with respect to a carrier frequency. The first UE performs an FDRSB impairment correction process on a signal based on the second information.

### TECHNICAL FIELD

The present disclosure relates generally to communication systems and, more particularly, to interference mitigation in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first user equipment (UE). The apparatus may include at least one memory and at least one processor coupled to the at least one memory. Based at least in part on information stored in the at least one memory, the at least one processor may be configured to transmit, to a network entity, first information for a frequency dependent residual side band (FDRSB) estimation and correction on the first UE; receive, from the network entity based on the first information, second information for a pilot signal of a second UE, where the first UE is frequency domain multiplexed (FDMed) with the second UE, and where a first frequency band of the first UE partially overlaps with a mirror frequency band of a second frequency band of the second UE with respect to a carrier frequency; and perform, based on the second information, an FDRSB impairment correction process on a signal.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive, from a first UE, first information for an FDRSB estimation and correction on the first UE; transmit, to the first UE based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and communicate with the first UE based on an FDRSB impairment correction process using the second information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of a signal spectrum impaired by frequency dependent residual side band (FDRSB).

FIG. 4B is a diagram illustrating an example of FDRSB suppression.

FIG. 5 is a diagram illustrating an example of the bandwidth allocation to multiple UEs and the corresponding mirror frequencies of the FDRSB.

FIG. 6 is a diagram illustrating another example of the bandwidth allocation to multiple UEs and the corresponding mirror frequencies of the FDRSB.

FIG. 7 is a call flow diagram illustrating a method of wireless communication in accordance with various aspects of the present disclosure.

FIG. 8 is a flowchart illustrating methods of wireless communication at a first UE in accordance with various aspects of the present disclosure.

FIG. 9 is a flowchart illustrating methods of wireless communication at a first UE in accordance with various aspects of the present disclosure.

FIG. 10 is a flowchart illustrating methods of wireless communication at a network entity in accordance with various aspects of the present disclosure.

FIG. 11 is a flowchart illustrating methods of wireless communication at a network entity in accordance with various aspects of the present disclosure.

FIG. 12 is a diagram illustrating an example of a hardware implementation for an example apparatus and/or UE.

FIG. 13 is a diagram illustrating an example of a hardware implementation for an example network entity.

### DETAILED DESCRIPTION

In wireless communication, frequency dependent residual side band (FDRSB) interference arises due to gain and phase mismatches between the in-phase (I) and quadrature (Q) transmit chains (e.g., IQ mismatches). These mismatches result in an undesired image at the mirror frequencies, which distorts the transmit (Tx) output signal. While FDRSB calibrations at the base station can enable the transmission of regular quadrature amplitude modulation (QAM), such as up to 256-QAM, higher order modulations, including super-QAM modulation such as 4K-QAM or 16K-QAM, asks for substantially lower residual FDRSB power to ensure the integrity and reliability of these modulations. Example aspects presented herein provide methods and apparatus for mitigating FDRSB impairments in super-QAM by enabling demodulation reference signals (DMRSs) sharing between frequency domain multiplexed (FDMed) user equipment (UEs).

Various aspects relate generally to wireless communication. Some aspects more specifically relate to interference mitigation for higher-order modulation (e.g., super-QAM) in wireless communication. In some examples, a first UE transmits to a network entity first information for an FDRSB estimation and correction on the first UE. Then, the first UE receives from the network entity second information for a pilot signal of a second UE based on the first information. The first UE may be FDMed with the second UE, and the first frequency band of the first UE may partially overlap with a mirror frequency band of the second frequency band of the second UE with respect to a carrier frequency. The first UE performs an FDRSB impairment correction process on a signal based on the second information. In some examples, the second information may include the pilot signal of the second UE on a portion of the second frequency band, and the corresponding portion of the mirror frequency band for the portion of the second frequency band may overlap with the first frequency band. In some examples, the first UE may evaluate whether an operational condition related to the FDRSB impairment correction process has been met. For example, the first UE may perform the FDRSB impairment correction process on the signal when the operational condition has been met. On the other hand, if the operational condition has not been met, the first UE may transmit to the network entity an indication for the omission of the second information.

Particular aspects of the subject matter described in this disclosure can be implemented to realize one or more of the following potential advantages. In some examples, by enabling FDMed UEs to share pilot sequence and modulation information, the described techniques allow each UE to estimate and correct for the FDRSB influence caused by other UE's transmissions, including transmissions involving higher-order modulations, thereby improving the reliability and efficiency of higher-order modulations transmissions. In some examples, by allowing UEs to disable FDRSB impairment correction processes based on their power levels or operational conditions, the described techniques provide increased flexibility, enhance power efficiency, and reduced the signaling overhead.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

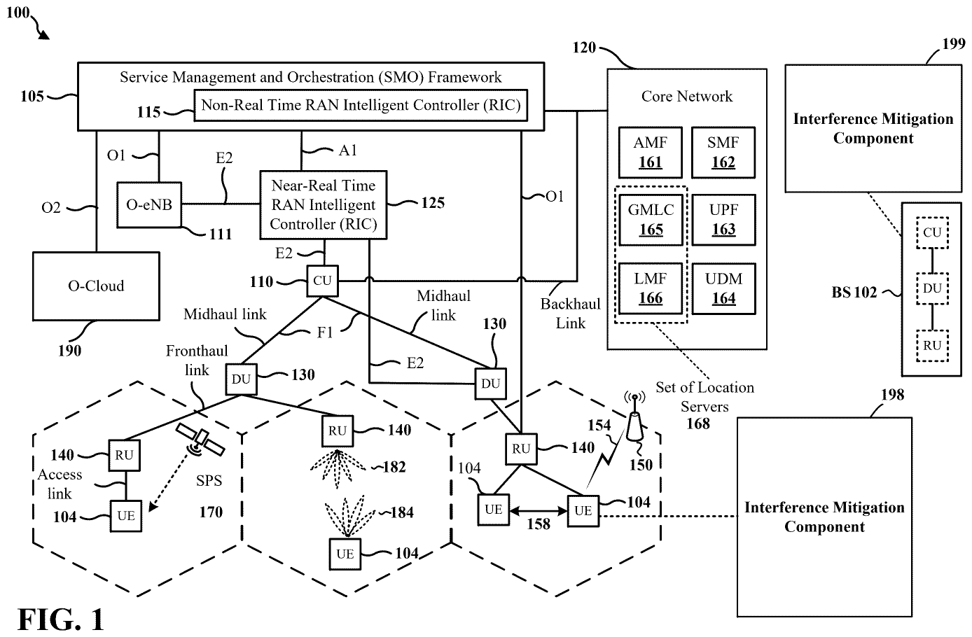

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the interference mitigation component 198. The interference mitigation component 198 may be configured to transmit, to a network entity, first information for an FDRSB estimation and correction on the first UE; receive, from the network entity based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and perform, based on the second information, an FDRSB impairment correction process on a signal. In certain aspects, the base station 102 may include the interference mitigation component 199. The interference mitigation component 199 may be configured to receive, from a first UE, first information for an FDRSB estimation and correction on the first UE; transmit, to the first UE based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and communicate with the first UE based on an FDRSB impairment correction process using the second information. Although the following description may be focused on 5G NR, the concepts described herein may be applicable to other similar areas, such as LTE, LTE-A, CDMA, GSM, and other wireless technologies.

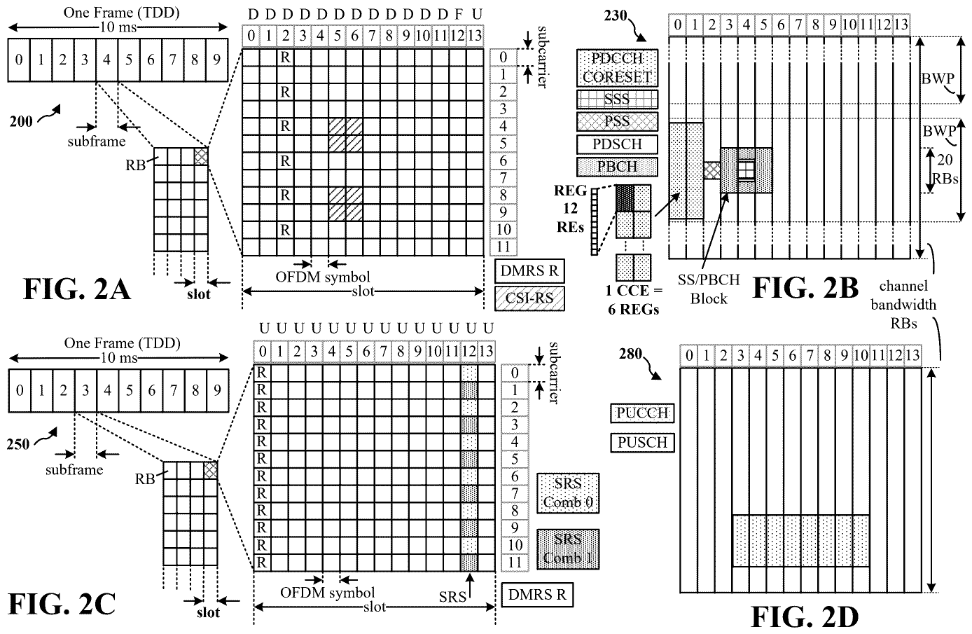

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

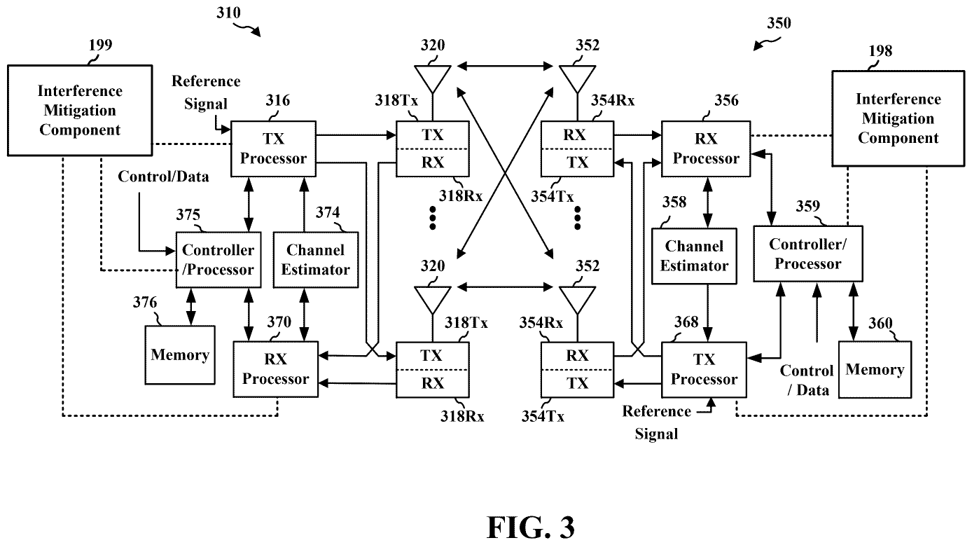

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the interference mitigation component 198 of FIG. 1.

At least one of the TX processor 316, the RX processor 370, and the controller/processor 375 may be configured to perform aspects in connection with the interference mitigation component 199 of FIG. 1.

In wireless communication, quadrature amplitude modulation (QAM) modulates a carrier signal by varying both its amplitude and phase. Each unique combination of amplitude and phase corresponds to a symbol, with each symbol representing a group of bits. For example, 16-QAM uses 16 different symbols, each symbol representing four bits, while 64-QAM uses 64 symbols, each symbol representing six bits.

Super QAM modulations, such as very high order modulation schemes like 4k-QAM and 16k-QAM, ask for a high signal-to-noise ratio (SNR) regime, which in return increases the sensitivity to radio frequency (RF) impairments. One of the most prominent impairments in such scenarios is FDRSB. The FDRSB impairment is caused by gain and phase mismatches between the I and Q transmit chains (e.g., IQ mismatches). This mismatch leads to an undesired image at the mirror frequencies, which distorts the transmit output signal.

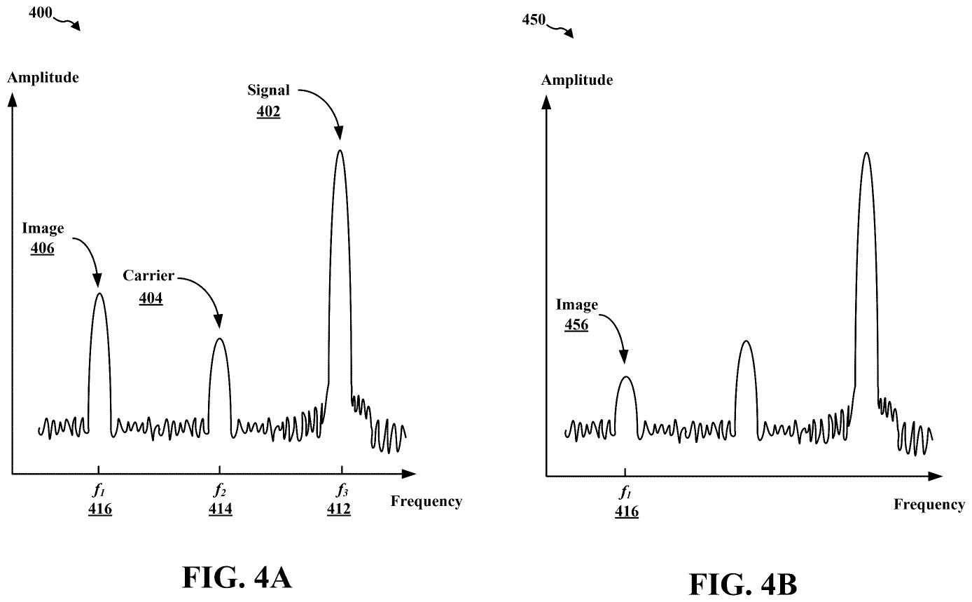

FIG. 4A is a diagram 400 illustrating an example of a signal spectrum impaired by FDRSB. As shown in FIG. 4A, the FDRSB impairment of the signal 402 (e.g., at frequency f₃ 412) may lead to an undesired image signal 406 at the mirror frequencies (e.g., at frequency f₁ 416) with respect to the carrier frequency 404 (e.g., f₂ 414), which may distort the transmit output signal. As a result, the mirror frequencies (e.g., f₁ 416) may experience a limiting noise floor that may restrict the link performance if the FDRSB impairment is not cancelled.

In some examples, the FDRSB may be calibrated at the base station (e.g., gNB) to enable the transmission of regular QAM modulations, such as up to 256-QAM. In order to achieve that modulation order (e.g., 256-QAM), the residual FDRSB impairment may be calibrated to be below −30 dB. However, higher order modulation, including super-QAM modulations such as 4K-QAM or 16K-QAM, asks for substantially lower residual FDRSB power to ensure the integrity and reliability of these modulations. Hence, an FDRSB mitigation mechanism becomes necessary to achieve super-QAM. For example, an FDRSB estimation and correction process may be used to suppress the noise floor at the image frequency. FIG. 4B is a diagram 450 illustrating an example of FDRSB suppression. As shown in FIG. 4B, an FDRSB mitigation mechanism (e.g., an FDRSB suppression) may suppress the noise floor at the image frequency f₁ 416 on the signal spectrum shown in diagram 400, resulting in a lowered image frequency 456 after the FDRSB suppression in diagram 450.

In the example in FIG. 4A, the receive signal y(f), considering the FDRSB impairment, may be expressed as:

y(f)=H(f)(s(f)k₁(f)+s*(−f)k₂(f))+w(f) (1)

where H(f) represents the channel response between the transmitter and the receiver, and s(f)k₁(f)+s*(−f)k₂(f) represents the transmit output signal. The transmit output signal includes a desired component (e.g., s(f)k₁(f)) and an undesired component (e.g., s*(−f)k₂(f)), which is caused by the FDRSB impairment. w(f) represents the noise during the transmission.

As shown in FIG. 4A and Equation (1), the frequency spectrum at the other side of the signal 402 (e.g., at the baseband) with respect to the carrier frequency 404, such as the mirror frequency f₁ 416, are distorted by the FDRSB of the signal 402. For example, considering a 100 MHz bandwidth that is allocated at [0,100] MHz (e.g., the baseband), the allocated spectrum has an image spectrum also appearing at [−100,0] MHz (e.g., the baseband) due to FDRSB. In this example, the allocated spectrum is not impaired because the impaired spectrum (e.g., [−100, 0] MHz) is out of band.

However, in another example where the 100 MHz bandwidth that is allocated at [−50,50] MHz (e.g., the baseband), each frequency may be interfering with its mirror frequency. For example, the subcarriers allocated at f=±30 MHz may be interfering with each other due to the FDRSB impairment. In this case, an FDRSB estimation and correction may be necessary to reduce the interference due to the FDRSB. In some examples, to enable the FDRSB estimation, a pilot signal (e.g., a demodulation reference signal (DMRS) or any known pilot signal) may be sent over the allocated bandwidth. After the channel estimation, the receiver may extract (or estimate) the FDRSB expression (e.g., Φ(f)=k₂(f)/k₁(f)) based on the pilot signal. For example, the UE may first estimate the channel (e.g., H(f)) using a channel estimation method. Then, based on the estimated channel (e.g., H(f)) and the pilot signal, the estimated FDRSB impairment (e.g., Φ(f)) may be determined.

After the estimated FDRSB impairment (e.g., Φ(f)) has been determined, the receiver (e.g., UE for downlink transmission) may apply FDRSB correction by removing (or subtracting) from the received signal at the downlink allocation (e.g., PDSCH allocation) the FDRSB expression multiplied by the data that is allocated at the mirror frequency.

To perform this correction, the receiver (e.g., UE for downlink transmission) may perform the FDRSB expression extraction (or estimation) and the subtraction of the estimated FDRSB expression from the signal (e.g., PDSCH). Hence, the receiver may have the knowledge regarding the pilot signal and the data at the mirror frequency (i.e., s(−f)). However, the pilot signal may cover the allocated bandwidth to the UE. Hence, in the cases where the allocated bandwidth is not symmetric with respect to the carrier signal frequency (e.g., the baseband), the pilot signal may not cover all the mirror frequencies. In the case where the mirror frequencies (e.g., f₁ 406) are not allocated. the FDRSB image may not interfere with any allocated bandwidth. On the other hand, if the allocated bandwidth is symmetric around the carrier frequency (e.g., the baseband), the FDRSB may have an influence on the received signal. In that case, the receiver may use an FDRSB estimation method to eliminate the FDRSB from the received signal.

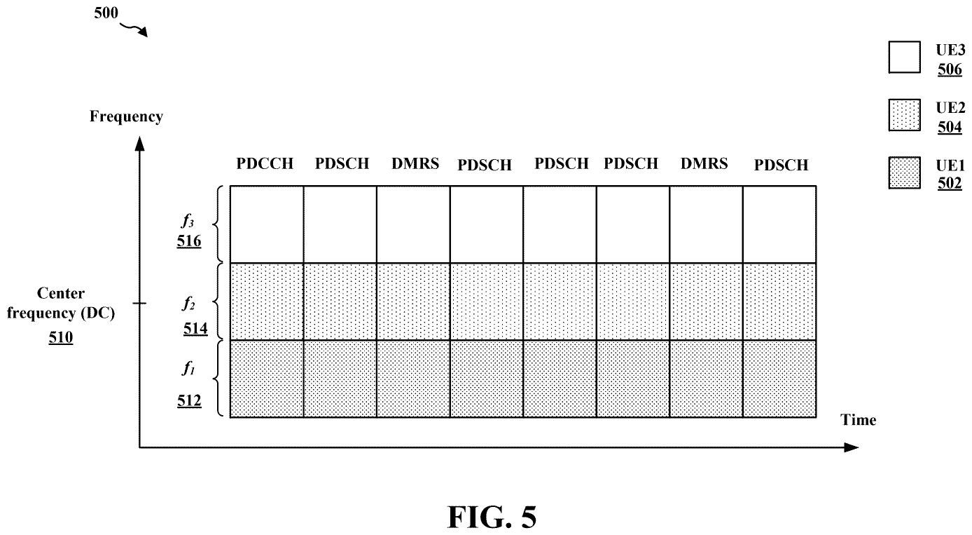

However, when the bandwidth is allocated to multiple UEs, such as multiple frequency domain multiplexed (FDMed) UEs, the UEs may not be able to accurate estimate the FDRSB expression (or FDRSB impairment) caused by other UEs on its allocated bandwidth. FIG. 5 is a diagram 500 illustrating an example of the bandwidth allocation to multiple UEs and corresponding mirror frequencies of the FDRSB. As shown in FIG. 5, three users (e.g., UE 1 502, UE 2 504, UE 3 506) may share a symmetric bandwidth around the center frequency (DC) 510. For example, the center frequency may be the frequency of the carrier signal. In the example in FIG. 5, UE 1 502 may have a 33.3 MHz bandwidth (e.g., f₁ 512) allocated at [−50, −16.67] MHz, UE 2 504 may have a 33.3 MHz bandwidth (e.g., f₂ 514) allocated at [−16.66, 16.66] MHz, and UE 3 506 may have a 33.3 MHz bandwidth (e.g., f₃ 516) allocated at [16.67, 50] MHz. In that case, the FDRSB of UE 2 504 may interfere with UE 2 504 itself since it has a symmetric allocation. Hence, UE 2 504 may eliminate the FDRSB without any additional knowledge related to the allocation of other UEs (e.g., UE 1 502 or UE 3 506).

However, in the example of FIG. 5, the FDRSB of UE 1 502 may interfere with UE 3 506, and the FDRSB of UE 3 506 may interfere with UE 1 502. Hence, UE 1 502 may use the pilot's information and the data at the allocated bandwidth (e.g., f₃ 516) of UE 3 506 to estimate and correct the FDRSB influence caused by the allocation of UE 3 506. Similarly, UE 3 506 may use the pilot's information and the data at the allocated bandwidth (e.g., f₁ 512) of UE 1 502 to estimate and correct the FDRSB influence caused by the allocation of UE 1 502. In contrast to UE 1 502 or UE 3 506, UE 2 504 may not need any additional information to mitigate the FDRSB influence. Example aspects presented herein provide methods and apparatus that enable the FDMed UEs, such as UE 1 502 and UE 3 506, to share their mirror frequencies data for the purpose of mitigating the FDRSB impairment. Some example aspects present a method for mitigating FDRSB impairments in super QAM by enabling DMRSs sharing between FDMed UEs. The method involves the sharing of pilot sequences and modulation orders to estimate and correct FDRSB across mirror frequencies; and utilizing known pilot signals for precise FDRSB estimation and correction, thereby enhancing spectral efficiency and supporting higher order modulations such as 4k-QAM and 16k-QAM. In some examples, the method for mitigating FDRSB impairments may also be referred to as the “FDRSB estimation and correction” procedure or the FDRSB mitigation method (or procedure).

In some aspects, the described FDRSB estimation and correction procedure may be applicable to downlink frequency domain multiplexing (FDM) from the base station and the served FDMed UEs. In some examples, the FDRSB estimation and correction procedure may begin with the base station sending a downlink request (e.g., a capability inquiry) to the served FDMed UEs to indicate whether they have the capability to perform the FDRSB estimation and correction procedure. For example, the downlink request may be sent at the beginning of the communication upon the cell's attachment and may be at the radio resource control (RRC), medium access control (MAC), or physical (PHY) level. In some examples, the base station may consider its level of FDRSB distortion with respect to the operated modulation and coding scheme (MCS) when deciding whether to begin the FDRSB estimation and correction procedure. For example, if the base station uses an MCS that is associated with an SNR much lower than the level of its FDRSB calibration, the base station may decide to disable the FDRSB estimation and correction procedure.

In some aspects, upon receiving the downlink request (e.g., the capability inquiry) from the base station, the UEs may send an uplink indication in response to the base station's downlink request, indicating whether they have the capability to perform the FDRSB estimation and correction procedure. For example, the uplink indication may be sent at the beginning of the communication upon the cell's attachment and may be at the RRC, MAC, or PHY level. Then, upon each FDM configuration, the base station may determine the UEs that are sharing the mirror frequencies with each other. For example, in the example in FIG. 5, the base station may determine that the mirror frequency of UE 1 502 may overlap with the allocated bandwidth (e.g., f₃ 516) of UE 3 506, and that the mirror frequency of UE 3 506 may overlap with the allocated bandwidth (e.g., f₁ 512) of UE 1 502. Based on this information, the base station will share the information of the pilot's sequence between those UEs. For example, the information of the pilot's sequence may be a DMRS or a pilot sequence or an index identifying the DMRS or the pilot sequence.

For example, in the example in FIG. 5, the pilot sequence of UE 3 506 at its mirror frequencies (e.g., f₁ 512) may be shared with UE 1 502, and the pilot sequence of UE 1 502 at its mirror frequencies (e.g., f₃ 516) may be shared with UE 3 506. On the other hand, UE 2 504 may not receive any additional pilot information since it can correct the FDRSB without that knowledge.

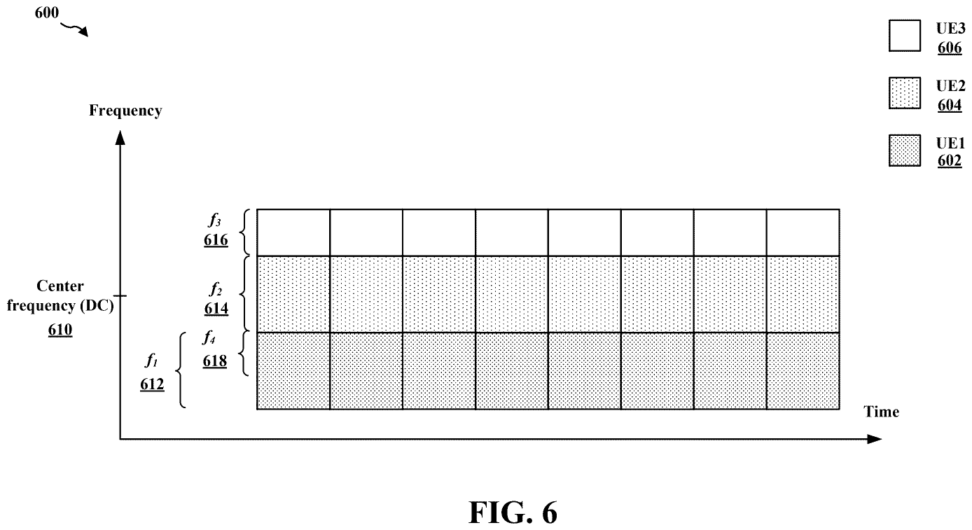

In some examples, a UE may receive the other UEs' pilot information at the portion their mirror frequencies that overlap with the UE’ allocated bandwidth. FIG. 6 is a diagram 600 illustrating an example of the bandwidth allocation to multiple UEs and the corresponding mirror frequencies of FDRSB. As shown in FIG. 6, three users (e.g., UE 1 602, UE 2 604, UE 3 606) may share a bandwidth around the center frequency (DC) 610. For example, the center frequency may be the frequency of the carrier signal. In the example in FIG. 6, UE 1 602 may have a 33.3 MHz bandwidth (e.g., f₁ 612) allocated at [−50, −16.67] MHz, UE 2 604 may have a 33.3 MHz bandwidth (e.g., f₂ 614) allocated at [−16.66, 16.66] MHz, and UE 3 606 may have a 13.3 MHz bandwidth (e.g., f₃ 616) allocated at [16.67, 30] MHz. In this case, UE 3 606 may receive the pilot information of UE 1 602 at a portion of the allocated bandwidth of UE 1 602 whose mirror frequency overlaps with the allocated frequency of UE 3 606, such as [−30, −16.67] MHz (e.g., f₄ 618). Although UE 1 602 may be allocated a larger bandwidth, such as [−50, −16.67] MHz (e.g., f₁ 612), UE 3 606 may not need the pilot information on the part of the allocated bandwidth (e.g., f₁ 612) of UE 1 602 whose mirror frequencies does not overlap with the allocated bandwidth (e.g., f₃ 616) of UE 3 606.

In some aspects, the base station may also send the modulation information (e.g., QAM order) of the interfering UE to improve the accuracy of the FDRSB correction. For example, in the example of FIG. 6, the base station may also send the modulation information (e.g., QAM order) of the UE 3 606 to UE 1 602, and send the modulation information (e.g., QAM order) of the UE 1 602 to UE 3 606. Based on the modulation information (e.g., QAM order) of interfering UE, the interfered UE may improve the FDRSB correction by doing hard slicing of the equalized signal prior to the demodulation.

In some aspects, after receiving the mirror frequencies pilot's information, and possibly the modulation order (e.g., QAM order) of the interfering UE, the UE (e.g., the interfered UE) may utilize this information to estimate and cancel the FDRSB impairment. The UE may use various methods to estimate and cancel the FDRSB impairment based on the additional information provided.

In some examples, the estimation of the FDRSB may use the pilot information at the mirror frequencies (e.g., s*(−f)) according to the following procedures. First, the UE may estimate the channel H(f) using a channel estimation method. Then, the UE may determine the residual error by subtracting the channel multiplied by the transmitted pilot (e.g., H(f)s(f)) from the received signal y(f). Afterwards, the UE may use the additional pilot knowledge at the mirror frequencies to reconstruct the impairment expression, considering the channel influence \tilde{H}(f)s*(−f)Φ(f). Finally, the UE may extract the FDRSB impairment Φ(f) by comparing the two expressions from the previous two steps. In some examples, the UE may update the received signal (e.g., y(f)) by subtracting the computed FDRSB influence from the received signal: y(f)−\tilde{H}(f)s*(−f)Φ(f) and repeat the above procedure with the updated received signal to improve the channel and FDRSB estimation until a satisfying error is achieved. While the estimation of FDRSB may be implemented using other methods, the pilot information at the mirror frequencies is indispensable, and the estimation cannot be performed without the pilot information at the mirror frequencies.

In some examples, the correction of the data may be performed according to the following procedures. First, using the pilot's information at the mirror frequencies (e.g., s(−f)) and the received signal in this bandwidth (e.g., y(−f)), the UE may estimate the channel H(−f). Then, the UE may remove the channel influence from the received signal (PDSCH) to determine s(−f). If the base station has also shared the configured modulation (e.g., QAM order) of the interfering UE, the UE may hard slice the output of the second step (e.g., s(−f)) to improve the accuracy. Finally, the UE may subtract the FDRSB influence (at the PDSCH): y(f)−\tilde{H}(f)s*(−f)Φ(f) to clean the FDRSB influence from the received signal. While the correction of FDRSB may be implemented using other methods, the pilot information at the mirror frequencies is indispensable, and the correction of FDRSB cannot be performed without the pilot information at the mirror frequencies.

In some aspects, when the mirror frequencies are no longer used or are partially by used an interfering UE, the base station may update or disable the sharing of the mirror frequencies information accordingly. For example, in the example of FIG. 5, if the transmission for UE 3 506 has stopped, UE 3 506 does not cause FDRSB impairment to UE 1 502. In that case, the base station may indicate to UE 1 502 that the mirror frequencies are no longer occupied by the UE 3 506, so that UE 1 502 may refrain from (or stop) performing the FDRSB impairment correction process.

In some aspects, each UE may determine to stop or start the FDRSB cancellation procedure based on whether an operational condition for performing the FDRSB cancelation procedure has been met. For example, the operational condition may be based on the UE's own operation limitations and conditions. For example, the operational condition may be determined based on the power level (or battery level) of the UE, e.g., when the UE enters or exits a low power mode or a low battery mode. For example, when the UE enters the low power mode or the lower battery mode (or when the battery level of the UE is less than a power threshold), the UE may stop the FDRSB cancelation procedure, and the UE may send an uplink indication to the base station, indicating that it will not need any additional pilot's knowledge or modulation knowledge from the base station, thereby saving the downlink overhead of sending such information. In some examples, before stopping the FDRSB cancelation procedure, the UE may evaluate and indicate what the new noise floor would be due to the FDRSB cancellation procedure being disabled, allowing the base station to change the operated MCS if needed. For example, the UE may calculate a noise level without the FDRSB cancelation procedure (e.g., an FDRSB impairment correction process) on a received signal, and transmit to the base station an indication for the calculated noise level.

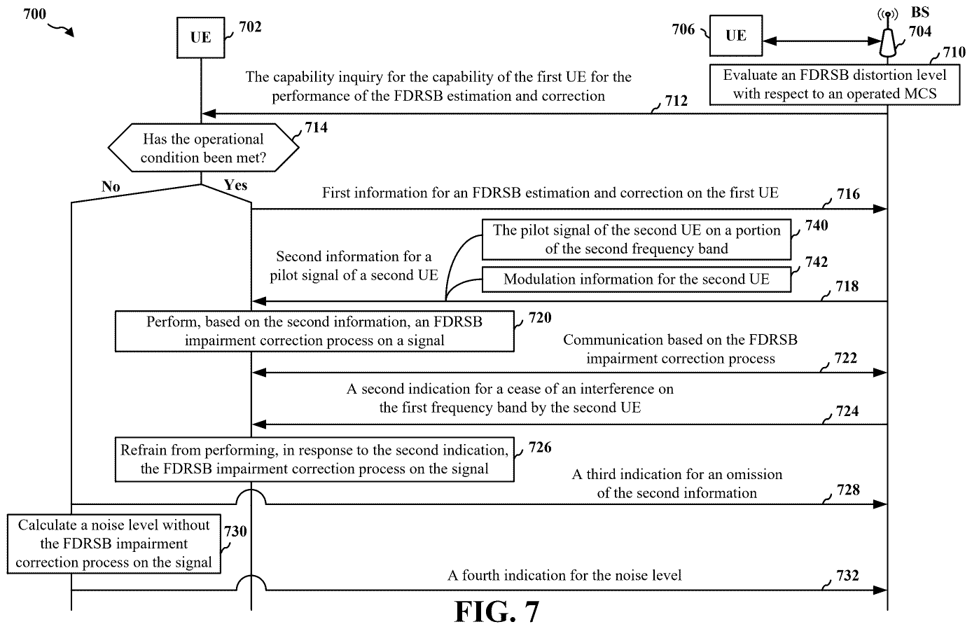

FIG. 7 is a call flow diagram 700 illustrating a method of wireless communication in accordance with various aspects of this present disclosure. Various aspects are described in connection with a first UE 702 and a base station 704. The aspects may be performed by the UE 702 or the base station 704 in aggregation and/or by one or more components of a base station 704 (e.g., a CU 110, a DU 130, and/or an RU 140). In some examples, the base station 704 may also be communicating with other UEs, such as a second UE 706.

As shown in FIG. 7, at 710, the base station 704 may evaluate an FDRSB distortion level (e.g., the FDRSB calibration level) with respect to an operated MCS to obtain an evaluation result, and the base station 704 may determine whether to start the FDRSB impairment correction process based on the evaluation result. In some examples, if the evaluation result indicates that the FDRSB impairment correction process is applicable, the base station 704 may, at 712, transmit a capability inquiry to the first UE 702 to start the FDRSB impairment correction process. On the other hand, if the base station 704 uses an operated MCS associated with an SNR lower than the level of its FDRSB calibration, the base station 704 may determine not to start (or disable) the FDRSB impairment correction process.

At 714, the first UE 702 may determine whether the operational condition for the FDRSB impairment correction process has been met. For example, whether the operational condition has been met may be determined based on the battery level of the UE 702 or whether the UE 702 is in a low power mode or low battery mode. In some examples, the operational condition may include the battery level of the first UE 702 is sufficiently high (e.g., higher than a power threshold) to perform the FDRSB impairment correction process.

In some aspects, if the first UE 702 has determined that the operational condition has been met, the first UE 702 may, at 716, transmit to base station 704 first information for an FDRSB estimation and correction on the first UE 702. In some examples, the first information may include an indication (e.g., a first indication) of the capability of the first UE 702 to perform the FDRSB estimation and correction.

At 718, the first UE 702 may receive from base station 704 second information for a pilot signal of the second UE 706 based on the first information. In some examples, the first UE 702 may be frequency domain multiplexed (FDMed) with the second UE 706. A first frequency band of the first UE 702 may at least partially overlap with a mirror frequency band of a second frequency band of the second UE 706 with respect to a carrier frequency. For example, the second information for the pilot signal of the second UE 706 may include a DMRS or a pilot sequence or an index identifying the DMRS or the pilot sequence of the second UE 706.

In some examples, the second information may include the pilot signal of the second UE 706 on a portion of the second frequency band (e.g., at 740), and a corresponding portion of the mirror frequency band for the portion of the second frequency band may overlap with the first frequency band. In some examples, the second information may further include modulation information (e.g., at 742) for the second UE 706, such as the QAM order.

At 720, the first UE 702 may perform, the FDRSB impairment correction process on a signal based on the second information. In some examples, to perform the FDRSB impairment correction process, the first UE 702 may estimate an FDRSB impairment of the second UE 706 on the first frequency band based on the second information, and correct the FDRSB impairment of the second UE 706 on the signal.

At 722, the first UE 702 may communicate with base station 704 based on the FDRSB impairment correction process using the second information. For example, for a received signal from the base station 704, the first UE 702 may estimate the FDRSB impairment of the second UE 706 and correct the FDRSB impairment on the signal based on the second information.

In some examples, the base station 704 may indicate the first UE 702 to stop the FDRSB impairment correction process. For example, at 724, the base station 704 may transmit to the first UE 702 an indication (e.g., a second indication) for a cease of an interference on the first frequency band by the second UE 706 when the transmission of the second UE 706 has stopped.

At 726, the first UE 702 may refrain from (or stop) performing the FDRSB impairment correction process on the signal in response to the second indication.

In some examples, the first UE 702 may determine, at 714, that the operational condition for performing the FDRSB impairment correction process has not been met (e.g., when the battery level of the first UE 702 is lower than the power threshold or when the first UE 702 has entered a lower power mode or a low battery mode). In this case, the first UE 702 may, at 728, transmit to the base station 704 an indication (e.g., a third indication) for an omission of the second information. For example, this indication may indicate the base station 704 that the transmission of the second information to the first UE 702 is not necessary.

In some examples, when the operational condition for performing the FDRSB impairment correction process has not been met, the first UE may, at 730, calculate a noise level without the FDRSB impairment correction process on the signal, and, at 732, transmit to base station 704 an indication (e.g., a fourth indication) for the noise level.

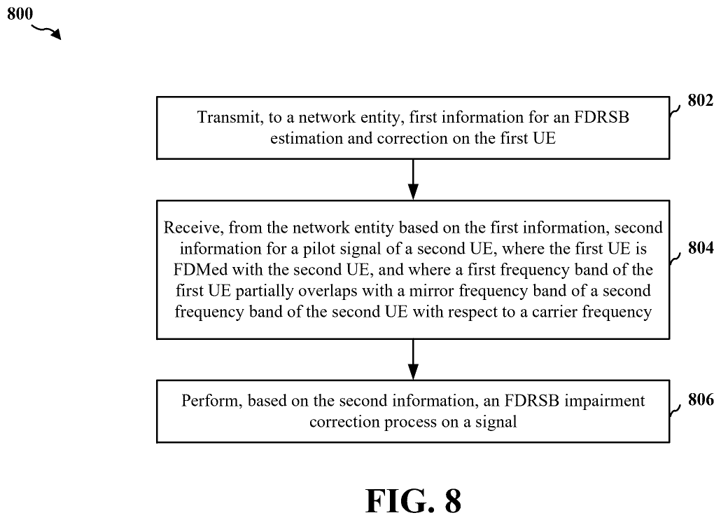

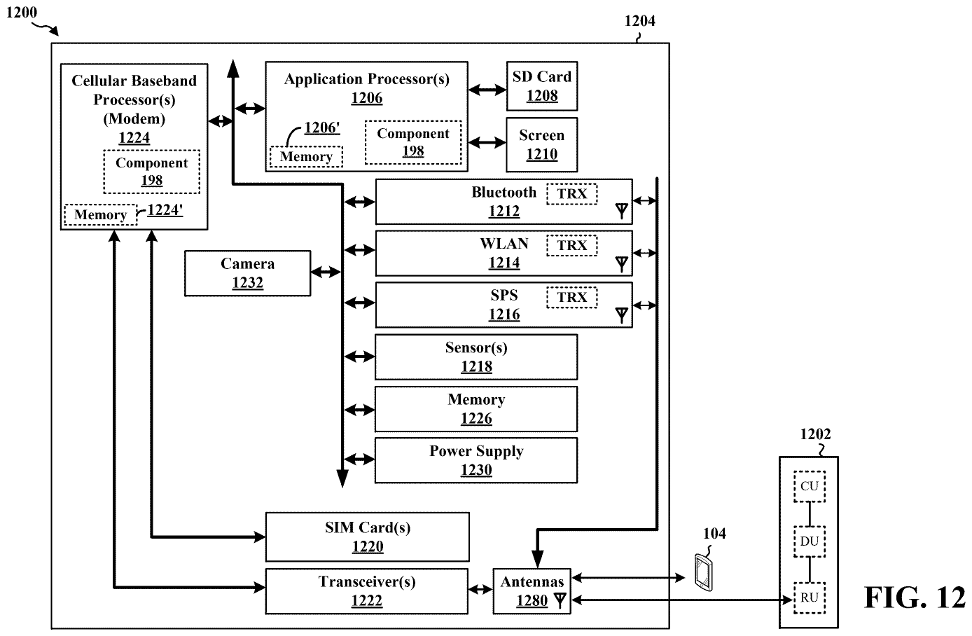

FIG. 8 is a flowchart 800 illustrating methods of wireless communication at a first UE in accordance with various aspects of the present disclosure. The method may be performed by a first UE in collaboration with a network entity and a second UE. The network entity may be a base station, or a component of a base station, in the access network of FIG. 1 or a core network component (e.g., base station 102, 310, 704; or the network entity 1202 in the hardware implementation of FIG. 12). The first UE may be the UE 104, 350, 702, or the apparatus 1204 in the hardware implementation of FIG. 12. The second UE may be UE 706. By enabling FDMed UEs to share pilot sequence and modulation information, the methods allow each UE to estimate and correct for the FDRSB influence caused by other UE's transmissions, including transmissions involving higher-order modulations, thereby improving the reliability and efficiency of higher-order modulations transmissions. Additionally, by allowing UEs to disable FDRSB impairment correction processes based on their power levels or operational conditions, the methods provide increased flexibility, enhance power efficiency, and reduced the signaling overhead.

As shown in FIG. 8, at 802, the first UE may transmit to a network entity first information for an FDRSB estimation and correction on the first UE. FIG. 5, FIG. 6, and FIG. 7 illustrate various aspects of the steps in connection with flowchart 800. For example, referring to FIG. 7, the first UE 702 may, at 716, transmit to a network entity (e.g., base station 704) first information for an FDRSB estimation and correction on the first UE 702. In some aspects, 802 may be performed by the interference mitigation component 198.

At 804, the first UE may receive, from the network entity based on the first information, second information for a pilot signal of a second UE. The first UE may be FDMed with the second UE, and the first frequency band of the first UE may partially overlap with a mirror frequency band of the second frequency band of the second UE with respect to a carrier frequency. For example, referring to FIG. 7, the first UE 702 may, at 718, receive from the network entity (e.g., base station 704), based on the first information, second information for a pilot signal of a second UE 706. Referring to FIG. 5, the first UE (e.g., UE 1 502) may be FDMed with the second UE (e.g., UE 3 506), and the first frequency band (e.g., f₁ 512) of the first UE (e.g., UE 1 502) may partially overlap with a mirror frequency band of the second frequency band (e.g., f₃ 516) of the second UE (e.g., UE 3 506) with respect to a carrier frequency (e.g., center frequency 510). In some aspects, 804 may be performed by the interference mitigation component 198.

At 806, the first UE may perform an FDRSB impairment correction process on a signal based on the second information. For example, referring to FIG. 7, the first UE 702 may, at 720, perform an FDRSB impairment correction process on a signal based on the second information. In some aspects, 806 may be performed by the interference mitigation component 198.

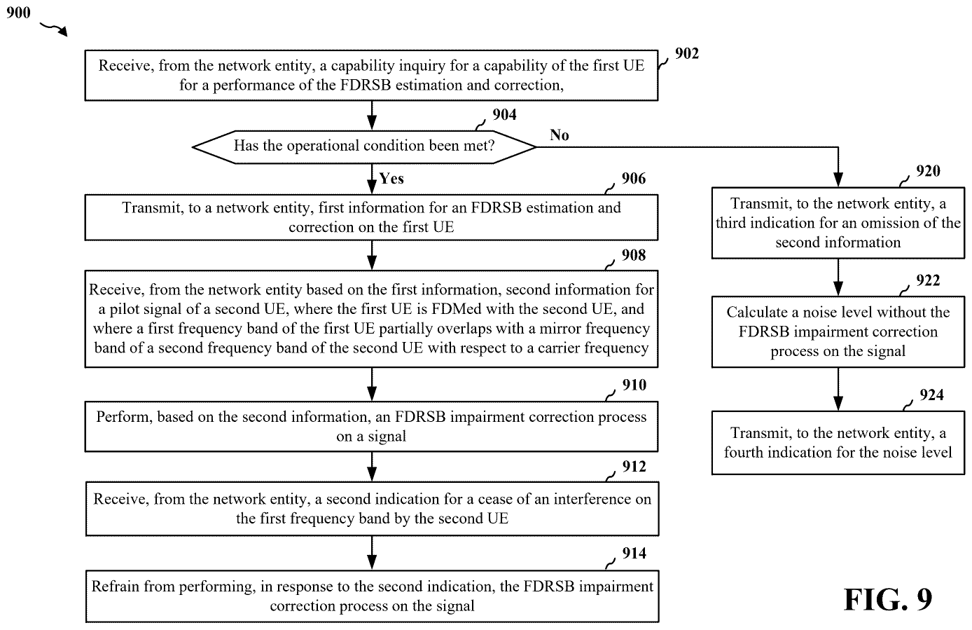

FIG. 9 is a flowchart 900 illustrating methods of wireless communication at a first UE in accordance with various aspects of the present disclosure. The method may be performed by a first UE in collaboration with a network entity and a second UE. The network entity may be a base station, or a component of a base station, in the access network of FIG. 1 or a core network component (e.g., base station 102, 310, 704; or the network entity 1202 in the hardware implementation of FIG. 12). The UE may be the UE 104, 350, 702, or the apparatus 1204 in the hardware implementation of FIG. 12. The second UE may be UE 706. By enabling FDMed UEs to share pilot sequence and modulation information, the methods allow each UE to estimate and correct for the FDRSB influence caused by other UE's transmissions, including transmissions involving higher-order modulations, thereby improving the reliability and efficiency of higher-order modulations transmissions. Additionally, by allowing UEs to disable FDRSB impairment correction processes based on their power levels or operational conditions, the methods provide increased flexibility, enhance power efficiency, and reduced the signaling overhead.

As shown in FIG. 9, at 906, the first UE may transmit to a network entity first information for an FDRSB estimation and correction on the first UE. FIG. 5, FIG. 6, and FIG. 7 illustrate various aspects of the steps in connection with flowchart 900. For example, referring to FIG. 7, the first UE 702 may, at 716, transmit to a network entity (e.g., base station 704) first information for an FDRSB estimation and correction on the first UE 702. In some aspects, 906 may be performed by the interference mitigation component 198.

At 908, the first UE may receive, from the network entity based on the first information, second information for a pilot signal of a second UE. The first UE may be FDMed with the second UE, and the first frequency band of the first UE may partially overlap with a mirror frequency band of the second frequency band of the second UE with respect to a carrier frequency. For example, referring to FIG. 7, the first UE 702 may, at 718, receive from the network entity (e.g., base station 704), based on the first information, second information for a pilot signal of a second UE 706. Referring to FIG. 5, the first UE (e.g., UE 1 502) may be FDMed with the second UE (e.g., UE 3 506), and the first frequency band (e.g., f₁ 512) of the first UE (e.g., UE 1 502) may partially overlap with a mirror frequency band of the second frequency band (e.g., f₃ 516) of the second UE (e.g., UE 3 506) with respect to a carrier frequency (e.g., center frequency 510). In some aspects, 908 may be performed by the interference mitigation component 198.

At 910, the first UE may perform an FDRSB impairment correction process on a signal based on the second information. For example, referring to FIG. 7, the first UE 702 may, at 720, perform an FDRSB impairment correction process on a signal based on the second information. In some aspects, 910 may be performed by the interference mitigation component 198.

In some aspects, at 902, the first UE may receive, from the network entity, a capability inquiry for a capability of the first UE for a performance of the FDRSB estimation and correction. The first UE may, at 906, transmit the first information of the FDRSB estimation and correction in response to the capability inquiry. In some examples, the first information may include a first indication of the capability for the performance of the FDRSB estimation and correction. For example, referring to FIG. 7, the first UE 702 may, at 712, receive from the network entity (e.g., base station 704) a capability inquiry for the capability of the first UE 702 for a performance of the FDRSB estimation and correction. The first UE 702 may, at 716, transmit the first information of the FDRSB estimation and correction in response to the capability inquiry. In some examples, the first information may include a first indication of the capability for the performance of the FDRSB estimation and correction. In some aspects, 902 may be performed by the interference mitigation component 198.

In some aspects, the first UE may receive the capability inquiry (e.g., at 902) via one of the RRC signaling (e.g., an RRC message) or a first MAC-CE. In some examples, the first UE may transmit the first information for the FDRSB estimation and correction (e.g., at 906) via the RRC signaling or a second MAC-CE. For example, referring to FIG. 7, the first UE 702 may receive the capability inquiry (e.g., at 712) via one of the RRC signaling or a first MAC-CE. In some examples, the first UE 702 may transmit the first information for the FDRSB estimation and correction (e.g., at 716) via the RRC signaling or a second MAC-CE.

In some aspects, the second information (e.g., at 908) may include the pilot signal of the second UE on a portion of the second frequency band. A corresponding portion of the mirror frequency band for the portion of the second frequency band may overlap with the first frequency band. For example, referring to FIG. 7, the second information (e.g., at 718) may include the pilot signal of the second UE 706 on a portion of the second frequency band (e.g., at 740). Referring to FIG. 6, a corresponding portion (e.g., f₄ 618) of the mirror frequency band for the portion of the second frequency band (e.g., f₃ 616) may overlap with the first frequency band (e.g., f₁ 612).

In some aspects, the second information (e.g., at 908) may further include modulation information for the second UE. For example, referring to FIG. 7, the second information (e.g., at 718) may further include modulation information for the second UE 706 (e.g., at 742).

In some aspects, the modulation information of the second UE may include a QAM order. For example, referring to FIG. 7, the modulation information of the second UE 706 (e.g., at 742) may include the QAM order.

In some aspects, to perform the FDRSB impairment correction process on the signal (e.g., at 910), the first UE may estimate, based on the second information, an FDRSB impairment of the second UE on the first frequency band; and correct the FDRSB impairment of the second UE on the signal. For example, referring to FIG. 5 and FIG. 7, to perform the FDRSB impairment correction process on the signal (e.g., at 720), the first UE 702 may estimate, based on the second information, an FDRSB impairment of the second UE 706 (e.g., UE 3 506) on the first frequency band (e.g., f₁ 516); and correct the FDRSB impairment of the second UE 706 (e.g., UE 3 506) on the signal.

In some aspects, at 912, the first UE may receive, from the network entity, a second indication for a cease of an interference on the first frequency band by the second UE, and, at 914, refrain from performing (or stop performing) the FDRSB impairment correction process on the signal in response to the second indication. For example, referring to FIG. 7, the first UE 702 may, at 724, receive from the network entity (e.g., base station 704) a second indication for a cease of an interference on the first frequency band by the second UE 706, and, at 726, refrain from performing (or stop performing) the FDRSB impairment correction process on the signal in response to the second indication. In some aspects, 912 and 914 may be performed by the interference mitigation component 198.

In some aspects, the first UE may, at 904, evaluate whether the operational condition has been met. For example, the operational condition may include the battery level of the first UE is sufficiently high (e.g., higher than a power threshold) for performing the FDRSB impairment correction on the signal. In some examples, the first UE may perform the FDRSB impairment correction process on the signal (e.g., at 910) when the operational condition has been met. For example, referring to FIG. 7, the first UE 702 may, at 714, evaluate whether the operational condition has been met. For example, the operational condition may include the battery level of the first UE is sufficiently high (e.g., higher than a power threshold) for performing the FDRSB impairment correction on the signal. In some examples, the first UE 702 may perform the FDRSB impairment correction process on the signal (e.g., at 720) when the operational condition has been met.

In some aspects, when the first UE has determined (e.g., at 904) that the operational condition has not been met (e.g., when the battery level of the first UE is lower than the power threshold), the first UE may, at 920, transmit to the network entity a third indication for an omission of the second information. For example, the third indication may be an uplink indication indicating the first UE does not need any additional pilot's knowledge or modulation knowledge, thereby saving the downlink overhead of sending such information from the network entity. For example, referring to FIG. 7, when the first UE has determined (e.g., at 714) that the operational condition has not been met (e.g., when the battery level of the first UE is lower than the power threshold), the first UE 702 may, at 728, transmit to the network entity (e.g., base station 704) a third indication for an omission of the second information. For example, the third indication may be an uplink indication indicating the first UE 702 does not need any additional pilot's knowledge or modulation knowledge, thereby saving the downlink overhead of sending such information from the network entity. In some aspects, 920 may be performed by the interference mitigation component 198.

In some aspects, if the first UE has determined (e.g., at 904) that the operational condition has not been met (e.g., when the battery level of the first UE is lower than the power threshold), the first UE may, at 922, calculate a noise level without the FDRSB impairment correction process on the signal, and, at 924, transmit a fourth indication for the noise level to the network entity. For example, referring to FIG. 7, if the first UE 702 has determined (e.g., at 714) that the operational condition has not been met (e.g., when the battery level of the first UE is lower than the power threshold), the first UE 702 may, at 730, calculate a noise level without the FDRSB impairment correction process on the signal, and, at 732, transmit a fourth indication for the noise level to the network entity. In some aspects, 922 and 924 may be performed by the interference mitigation component 198.

In some aspects, the pilot signal may include a DMRS. For example, referring to FIG. 7, the pilot signal (e.g., at 718) may include a DMRS.

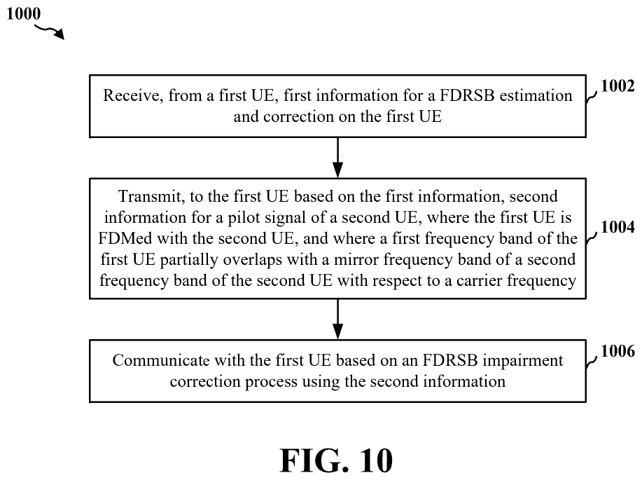

FIG. 10 is a flowchart 1000 illustrating methods of wireless communication at a network entity in accordance with various aspects of the present disclosure. The method may be performed by a network entity in collaboration with a first UE and a second UE. The network entity may be a base station, or a component of a base station, in the access network of FIG. 1 or a core network component (e.g., base station 102, 310, 704; or the network entity 1202 in the hardware implementation of FIG. 12). The first UE may be the UE 104, 350, 702, or the apparatus 1204 in the hardware implementation of FIG. 12. The second UE may be UE 706. By enabling FDMed UEs to share pilot sequence and modulation information, the methods allow each UE to estimate and correct for the FDRSB influence caused by other UE's transmissions, including transmissions involving higher-order modulations, thereby improving the reliability and efficiency of higher-order modulations transmissions. Additionally, by allowing UEs to disable FDRSB impairment correction processes based on their power levels or operational conditions, the methods provide increased flexibility, enhance power efficiency, and reduced the signaling overhead.

As shown in FIG. 10, at 1002, the network entity may receive, from a first UE, first information for an FDRSB estimation and correction on the first UE. FIG. 5, FIG. 6, and FIG. 7 illustrate various aspects of the steps in connection with flowchart 1000. For example, referring to FIG. 7, the network entity (e.g., base station 704) may, at 716, receive from the first UE 702 first information for an FDRSB estimation and correction on the first UE 702. In some aspects, 1002 may be performed by the interference mitigation component 199.

At 1004, the network entity may transmit, to the first UE based on the first information, second information for a pilot signal of a second UE. The first UE may be FDMed with the second UE, and the first frequency band of the first UE may partially overlap with a mirror frequency band of the second frequency band of the second UE with respect to a carrier frequency. For example, referring to FIG. 7, the network entity (e.g., base station 704) may, at 718, transmit to the first UE 702, based on the first information, second information for a pilot signal of a second UE 706. Referring to FIG. 5, the first UE (e.g., UE 1 502) may be FDMed with the second UE (e.g., UE 3 506), and the first frequency band (e.g., f₁ 512) of the first UE (e.g., UE 1 502) may partially overlap with a mirror frequency band of the second frequency band (e.g., f₃ 516) of the second UE (e.g., UE 3 506) with respect to a carrier frequency (e.g., center frequency 510). In some aspects, 1004 may be performed by the interference mitigation component 199.

At 1006, the network entity may communicate with the first UE based on an FDRSB impairment correction process using the second information. For example, referring to FIG. 7, the network entity (e.g., base station 704) may, at 722, communicate with the first UE 702 based on an FDRSB impairment correction process using the second information. In some aspects, 1006 may be performed by the interference mitigation component 199.

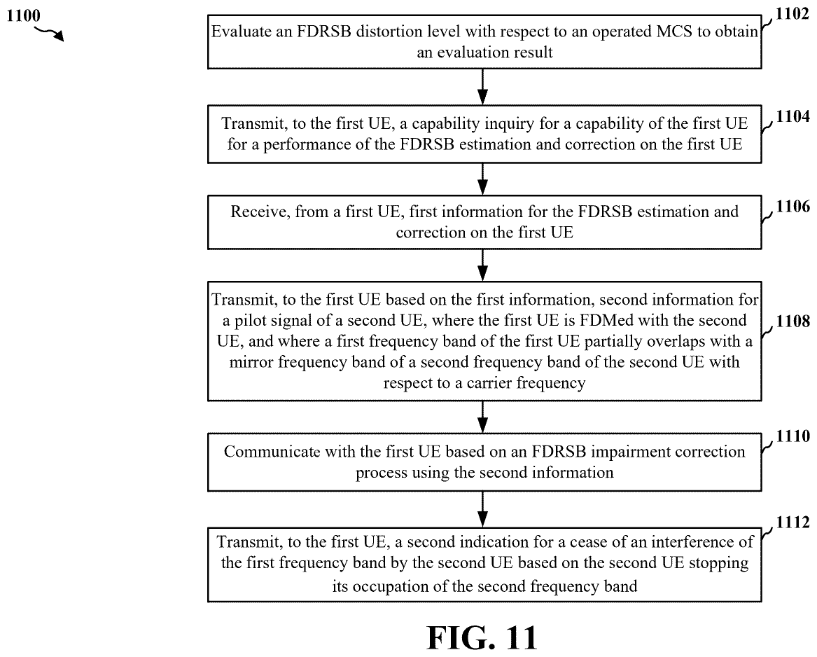

FIG. 11 is a flowchart 1100 illustrating methods of wireless communication at a network entity in accordance with various aspects of the present disclosure. The method may be performed by a network entity in collaboration with a first UE and a second UE. The network entity may be a base station, or a component of a base station, in the access network of FIG. 1 or a core network component (e.g., base station 102, 310, 704; or the network entity 1202 in the hardware implementation of FIG. 12). The first UE may be the UE 104, 350, 702, or the apparatus 1204 in the hardware implementation of FIG. 12. The second UE may be UE 706. By enabling FDMed UEs to share pilot sequence and modulation information, the methods allow each UE to estimate and correct for the FDRSB influence caused by other UE's transmissions, including transmissions involving higher-order modulations, thereby improving the reliability and efficiency of higher-order modulations transmissions. Additionally, by allowing UEs to disable FDRSB impairment correction processes based on their power levels or operational conditions, the methods provide increased flexibility, enhance power efficiency, and reduced the signaling overhead.

As shown in FIG. 11, at 1106, the network entity may receive, from a first UE, first information for an FDRSB estimation and correction on the first UE. FIG. 5, FIG. 6, and FIG. 7 illustrate various aspects of the steps in connection with flowchart 1100. For example, referring to FIG. 7, the network entity (e.g., base station 704) may, at 716, receive from the first UE 702 first information for an FDRSB estimation and correction on the first UE 702. In some aspects, 1106 may be performed by the interference mitigation component 199.

At 1108, the network entity may transmit, to the first UE based on the first information, second information for a pilot signal of a second UE. The first UE may be FDMed with the second UE, and the first frequency band of the first UE may partially overlap with a mirror frequency band of the second frequency band of the second UE with respect to a carrier frequency. For example, referring to FIG. 7, the network entity (e.g., base station 704) may, at 718, transmit to the first UE 702, based on the first information, second information for a pilot signal of a second UE 706. Referring to FIG. 5, the first UE (e.g., UE 1 502) may be FDMed with the second UE (e.g., UE 3 506), and the first frequency band (e.g., f₁ 512) of the first UE (e.g., UE 1 502) may partially overlap with a mirror frequency band of the second frequency band (e.g., f₃ 516) of the second UE (e.g., UE 3 506) with respect to a carrier frequency (e.g., center frequency 510). In some aspects, 1108 may be performed by the interference mitigation component 199.

At 1110, the network entity may communicate with the first UE based on an FDRSB impairment correction process using the second information. For example, referring to FIG. 7, the network entity (e.g., base station 704) may, at 722, communicate with the first UE 702 based on an FDRSB impairment correction process using the second information. In some aspects, 1110 may be performed by the interference mitigation component 199.

In some aspects, at 1104, the network entity may transmit, to the first UE, a capability inquiry for a capability of the first UE for a performance of the FDRSB estimation and correction on the first UE. The reception of the first information for the FDRSB estimation and correction (e.g., at 1106) may be based on the capability inquiry. For example, referring to FIG. 7, the network entity (e.g., base station 704) may, at 712, transmit to the first UE 702 a capability inquiry for a capability of the first UE 702 for a performance of the FDRSB estimation and correction on the first UE. The reception of the first information for the FDRSB estimation and correction (e.g., at 716) may be based on the capability inquiry. In some aspects, 1104 may be performed by the interference mitigation component 199.

In some aspects, at 1102, the network entity may evaluate an FDRSB distortion level with respect to an operated MCS to obtain an evaluation result. At 1104, the network entity may transmit the capability inquiry in response to the evaluation result indicating the FDRSB impairment correction process is applicable. For example, referring to FIG. 7, the network entity (e.g., base station 704) may, at 710, evaluate an FDRSB distortion level with respect to an operated MCS to obtain an evaluation result. At 712, the network entity (e.g., base station 704) may transmit the capability inquiry in response to the evaluation result indicating the FDRSB impairment correction process is applicable. In some aspects, 1102 may be performed by the interference mitigation component 199.

In some aspects, the second information (e.g., at 1108) may include the pilot signal of the second UE on a portion of the second frequency band. The corresponding portion of the mirror frequency band for the portion of the second frequency band may overlap with the first frequency band. For example, referring to FIG. 7, the second information (e.g., at 718) may include the pilot signal of the second UE on a portion of the second frequency band (e.g., at 740). The corresponding portion of the mirror frequency band for the portion of the second frequency band may overlap with the first frequency band.

In some aspects, the second information (e.g., at 1108) may further include modulation information for the second UE. For example, referring to FIG. 7, the second information (e.g., at 718) may further include modulation information for the second UE (e.g., at 742).

In some aspects, the modulation information of the second UE may include the QAM order. For example, referring to FIG. 7, the modulation information of the second UE 706 (e.g., at 742) may include the QAM order.

In some aspects, at 1112, the network entity may transmit, to the first UE, a second indication for the cease of an interference of the first frequency band by the second UE based on the second UE stopping its occupation of the second frequency band. For example, referring to FIG. 7, the network entity (e.g., base station 704) may, at 724, transmit to the first UE 702 a second indication for the cease of an interference of the first frequency band by the second UE 706 based on the second UE 706 stopping its occupation of the second frequency band. In some aspects, 1112 may be performed by the interference mitigation component 199.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor (or processing circuitry) 1224 (also referred to as a modem) coupled to one or more transceivers 1222 (e.g., cellular RF transceiver). The cellular baseband processor(s) (or processing circuitry) 1224 may include at least one on-chip memory (or memory circuitry) 1224′. In some aspects, the apparatus 1204 may further include one or more subscriber identity modules (SIM) cards 1220 and at least one application processor (or processing circuitry) 1206 coupled to a secure digital (SD) card 1208 and a screen 1210. The application processor(s) (or processing circuitry) 1206 may include on-chip memory (or memory circuitry) 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) (or processing circuitry) 1224 communicates through the transceiver(s) 1222 via one or more antennas 1280 with the UE 104 and/or with an RU associated with a network entity 1202. The cellular baseband processor(s) (or processing circuitry) 1224 and the application processor(s) (or processing circuitry) 1206 may each include a computer-readable medium/memory (or memory circuitry) 1224′, 1206′, respectively. The additional memory modules 1226 may also be considered a computer-readable medium/memory (or memory circuitry). Each computer-readable medium/memory (or memory circuitry) 1224′, 1206′, 1226 may be non-transitory. The cellular baseband processor(s) (or processing circuitry) 1224 and the application processor(s) (or processing circuitry) 1206 are each responsible for general processing, including the execution of software stored on the computer-readable medium/memory (or memory circuitry). The software, when executed by the cellular baseband processor(s) (or processing circuitry) 1224/application processor(s) (or processing circuitry) 1206, causes the cellular baseband processor(s) (or processing circuitry) 1224/application processor(s) (or processing circuitry) 1206 to perform the various functions described supra. The cellular baseband processor(s) (or processing circuitry) 1224 and the application processor(s) (or processing circuitry) 1206 are configured to perform the various functions described supra based at least in part of the information stored in the memory (or memory circuitry). That is, the cellular baseband processor(s) (or processing circuitry) 1224 and the application processor(s) (or processing circuitry) 1206 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1224/application processor(s) (or processing circuitry) 1206 when executing software. The cellular baseband processor(s) (or processing circuitry) 1224/application processor(s) (or processing circuitry) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) (or processing circuitry) 1224 and/or the application processor(s) (or processing circuitry) 1206, and in another configuration, the apparatus 1204 may be the entire UE (e.g., see UE 350 of FIG. 3) and include the additional modules of the apparatus 1204.

As discussed supra, the component 198 may be configured to transmit, to a network entity, first information for an FDRSB estimation and correction on the first UE; receive, from the network entity based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and perform, based on the second information, an FDRSB impairment correction process on a signal. The component 198 may be further configured to perform any of the aspects described in connection with the flowcharts in FIG. 8 and FIG. 9, and/or performed by the UE 702 in FIG. 7. The component 198 may be within the cellular baseband processor(s) (or processing circuitry) 1224, the application processor(s) (or processing circuitry) 1206, or both the cellular baseband processor(s) (or processing circuitry) 1224 and the application processor(s) (or processing circuitry) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) (or processing circuitry) 1224 and/or the application processor(s) (or processing circuitry) 1206, includes means for transmitting, to a network entity, first information for an FDRSB estimation and correction on the first UE; means for receiving, from the network entity based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and means for performing, based on the second information, an FDRSB impairment correction process on a signal. The apparatus 1204 may further include means for performing any of the aspects described in connection with the flowcharts in FIG. 8 and FIG. 9, and/or aspects performed by the UE 702 in FIG. 7. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

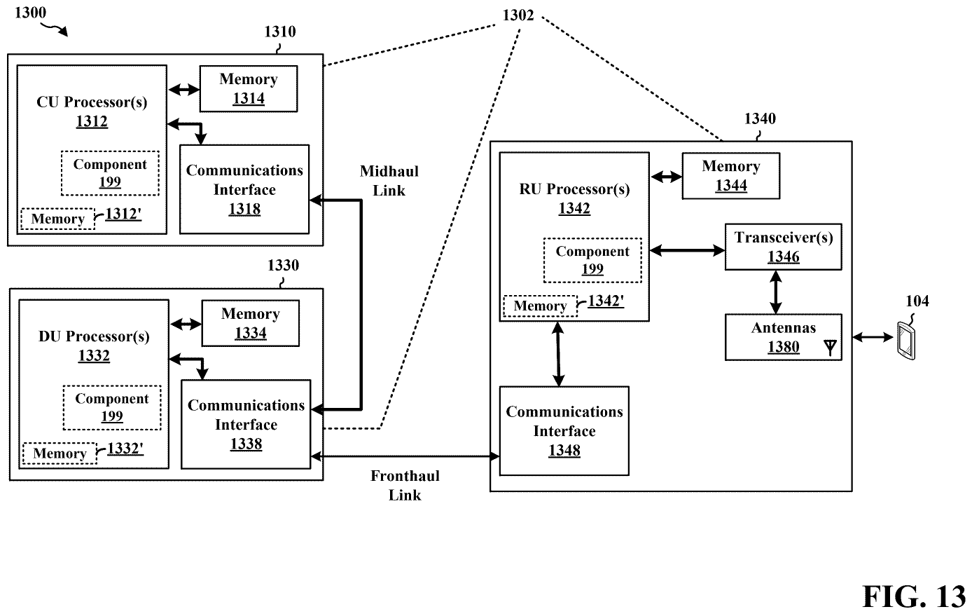

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor (or processing circuitry) 1312. The CU processor(s) (or processing circuitry) 1312 may include on-chip memory (or memory circuitry) 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor (or processing circuitry) 1332. The DU processor(s) (or processing circuitry) 1332 may include on-chip memory (or memory circuitry) 1332′. In some aspects, the DU 1330 may further include additional memory modules 1334 and a communications interface 1338. The DU 1330 communicates with the RU 1340 through a fronthaul link. The RU 1340 may include at least one RU processor (or processing circuitry) 1342. The RU processor(s) (or processing circuitry) 1342 may include on-chip memory (or memory circuitry) 1342′. In some aspects, the RU 1340 may further include additional memory modules 1344, one or more transceivers 1346, antennas 1380, and a communications interface 1348. The RU 1340 communicates with the UE 104. The on-chip memory (or memory circuitry) 1312′, 1332′, 1342′ and the additional memory modules 1314, 1334, 1344 may each be considered a computer-readable medium/memory (or memory circuitry). Each computer-readable medium/memory (or memory circuitry) may be non-transitory. Each of the processors (or processing circuitry) 1312, 1332, 1342 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a first UE, first information for an FDRSB estimation and correction on the first UE; transmit, to the first UE based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and communicate with the first UE based on an FDRSB impairment correction process using the second information. The component 199 may be further configured to perform any of the aspects described in connection with the flowcharts in FIG. 10 and FIG. 11, and/or performed by the base station 704 in FIG. 7. The component 199 may be within one or more processors (or processing circuitry) of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 includes means for receiving, from a first UE, first information for an FDRSB estimation and correction on the first UE; means for transmitting, to the first UE based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and means for communicating with the first UE based on an FDRSB impairment correction process using the second information. The network entity 1302 may further include means for performing any of the aspects described in connection with the flowcharts in FIG. 10 and FIG. 11, and/or aspects performed by the base station 704 in FIG. 7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first UE. The method may include transmitting, to a network entity, first information for an FDRSB estimation and correction on the first UE; receiving, from the network entity based on the first information, second information for a pilot signal of a second UE, where the first UE is FDMed with the second UE, and where a first frequency band of the first UE partially overlaps with a mirror frequency band of a second frequency band of the second UE with respect to a carrier frequency; and performing, based on the second information, an FDRSB impairment correction process on a signal. By enabling FDMed UEs to share pilot sequence and modulation information, the methods allow each UE to estimate and correct for the FDRSB influence caused by other UE's transmissions, including transmissions involving higher-order modulations, thereby improving the reliability and efficiency of higher-order modulations transmissions. Additionally, by allowing UEs to disable FDRSB impairment correction processes based on their power levels or operational conditions, the methods provide increased flexibility, enhance power efficiency, and reduced the signaling overhead.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.”

The following aspects are illustrative only and may be combined with other aspects or teachings described herein, without limitation.

Aspect 1 is a method of wireless communication at a first UE. The method includes transmitting, to a network entity, first information for a frequency dependent residual side band (FDRSB) estimation and correction on the first UE; receiving, from the network entity based on the first information, second information for a pilot signal of a second UE, wherein the first UE is frequency domain multiplexed (FDMed) with the second UE, and wherein a first frequency band of the first UE partially overlaps with a mirror frequency band of a second frequency band of the second UE with respect to a carrier frequency; and performing, based on the second information, an FDRSB impairment correction process on a signal.

Aspect 2 is the method of aspect 1, where the method further includes receiving, from the network entity, a capability inquiry for a capability of the first UE for a performance of the FDRSB estimation and correction, and wherein transmitting the first information of the FDRSB estimation and correction comprises transmitting, in response to the capability inquiry, the first information of the FDRSB estimation and correction, wherein the first information includes a first indication of the capability for the performance of the FDRSB estimation and correction.

Aspect 3 is the method of aspect 2, wherein receiving the capability inquiry comprises receiving, via one of radio resource control (RRC) signaling or a first medium access control (MAC)-control element (MAC-CE), the capability inquiry, and wherein transmitting the first information for the FDRSB estimation and correction comprises transmitting, via the RRC signaling or a second MAC-CE, the first information for the FDRSB estimation and correction.

Aspect 4 is the method of any of aspects 1 to 2, wherein the second information includes the pilot signal of the second UE on a portion of the second frequency band, wherein a corresponding portion of the mirror frequency band for the portion of the second frequency band overlaps with the first frequency band.

Aspect 5 is the method of aspect 4, wherein the second information further includes modulation information for the second UE.

Aspect 6 is the method of aspect 5, wherein the modulation information of the second UE includes a quadrature amplitude modulation (QAM) order.

Aspect 7 is the method of aspect 4, wherein performing the FDRSB impairment correction process on the signal comprises estimating, based on the second information, an FDRSB impairment of the second UE on the first frequency band; and correcting the FDRSB impairment of the second UE on the signal.

Aspect 8 is the method of aspect 4, where the method further includes receiving, from the network entity, a second indication for a cease of an interference on the first frequency band by the second UE; and refraining from performing, in response to the second indication, the FDRSB impairment correction process on the signal.

Aspect 9 is the method of any of aspects 1 to 8, wherein performing the FDRSB impairment correction process on the signal comprises performing, based on an operational condition being met, the FDRSB impairment correction process on the signal.

Aspect 10 is the method of aspect 9, wherein the operational condition includes a battery level of the first UE is higher than a power threshold.

Aspect 11 is the method of any of aspects 1 to 8, where the method further includes transmitting, to the network entity in response to an operational condition not being met, a third indication for an omission of the second information.

Aspect 12 is the method of aspect 11, where the method further includes calculating a noise level without the FDRSB impairment correction process on the signal; and transmitting, to the network entity, a fourth indication for the noise level.

Aspect 13 is the method of any of aspects 1 to 12, wherein the pilot signal includes a demodulation reference signal (DMRS).

Aspect 14 is an apparatus for wireless communication at a first UE, comprising: at least one memory; and at least one processor coupled to the at least one memory, the at least one processor is configured to perform the method of any of aspects 1 to 13.

Aspect 15 is the apparatus for wireless communication at a first UE, comprising means for performing each step in the method of any of aspects 1-13.

Aspect 16 is an apparatus of any of aspects 14-15, further comprising a transceiver configured to receive or to transmit in association with the method of any of aspects 1-13.

Aspect 17 is a computer-readable medium (e.g., a non-transitory computer-readable medium) storing computer executable code at a first UE, the code when executed by at least one processor causes the at least one processor to perform the method of any of aspects 1-13.

Aspect 18 is a method of wireless communication at a network entity. The method includes receiving, from a first user equipment (UE), first information for a frequency dependent residual side band (FDRSB) estimation and correction on the first UE; transmitting, to the first UE based on the first information, second information for a pilot signal of a second UE, wherein the first UE is frequency domain multiplexed (FDMed) with the second UE, and wherein a first frequency band of the first UE partially overlaps with a mirror frequency band of a second frequency band of the second UE with respect to a carrier frequency; and communicating with the first UE based on an FDRSB impairment correction process using the second information.

Aspect 19 is the method of aspect 18, wherein the method further includes transmitting, to the first UE, a capability inquiry for a capability of the first UE for a performance of the FDRSB estimation and correction on the first UE, and wherein a reception of the first information for the FDRSB estimation and correction is based on the capability inquiry.

Aspect 20 is the method of any of aspects 18 to 19, wherein the method further includes evaluating an FDRSB distortion level with respect to an operated modulation and coding scheme (MCS) to obtain an evaluation result, and wherein transmitting the capability inquiry comprises transmitting, in response to the evaluation result indicating the FDRSB impairment correction process is applicable, the capability inquiry.

Aspect 21 is the method of aspect 19, wherein the second information includes the pilot signal of the second UE on a portion of the second frequency band, wherein a corresponding portion of the mirror frequency band for the portion of the second frequency band overlaps with the first frequency band.

Aspect 22 is the method of aspect 21, wherein the second information further includes modulation information for the second UE.

Aspect 23 is the method of aspect 22, wherein the modulation information of the second UE includes a quadrature amplitude modulation (QAM) order.

Aspect 24 is the method of any of aspects 18 to 21, wherein the method further includes transmitting, to the first UE, a second indication for a cease of an interference of the first frequency band by the second UE based on the second UE stopping its occupation of the second frequency band.

Aspect 25 is an apparatus for wireless communication at a network entity, comprising: at least one memory; and at least one processor coupled to the at least one memory and, where the at least one processor is configured to perform the method of any of aspects 18-24.

Aspect 26 is the apparatus for wireless communication at a network entity, comprising means for performing each step in the method of any of aspects 18-24.

Aspect 27 is an apparatus of any of aspects 25-26, further comprising a transceiver configured to receive or to transmit in association with the method of any of aspects 18-24.

Aspect 28 is a computer-readable medium (e.g., a non-transitory computer-readable medium) storing computer executable code at a network entity, the code when executed by at least one processor causes the at least one processor to perform the method of any of aspects 18-24.

What is claimed is:

1. An apparatus for wireless communication at a first user equipment (UE), comprising:
at least one memory; and
at least one processor coupled to the at least one memory and, based at least in part on information stored in the at least one memory, the at least one processor is configured to:
transmit, to a network entity, first information for a frequency dependent residual side band (FDRSB) estimation and correction on the first UE;
receive, from the network entity based on the first information, second information for a pilot signal of a second UE, wherein the first UE is frequency domain multiplexed (FDMed) with the second UE, and wherein a first frequency band of the first UE partially overlaps with a mirror frequency band of a second frequency band of the second UE with respect to a carrier frequency; and
perform, based on the second information, an FDRSB impairment correction process on a signal.

2. The apparatus of claim 1, further comprising a transceiver coupled to the at least one processor, wherein to transmit the first information, the at least one processor is configured to transmit the first information via the transceiver, and wherein the at least one processor is further configured to:
receive, from the network entity, a capability inquiry for a capability of the first UE for a performance of the FDRSB estimation and correction, and wherein to transmit the first information of the FDRSB estimation and correction, the at least one processor is configured to:
transmit, in response to the capability inquiry, the first information of the FDRSB estimation and correction, wherein the first information includes a first indication of the capability for the performance of the FDRSB estimation and correction.

3. The apparatus of claim 2, wherein to receive the capability inquiry, the at least one processor is configured to:
receive, via one of radio resource control (RRC) signaling or a first medium access control (MAC)-control element (MAC-CE), the capability inquiry, and wherein to transmit the first information for the FDRSB estimation and correction, the at least one processor is configured to:
transmit, via the RRC signaling or a second MAC-CE, the first information for the FDRSB estimation and correction.

4. The apparatus of claim 2, wherein the second information includes the pilot signal of the second UE on a portion of the second frequency band, wherein a corresponding portion of the mirror frequency band for the portion of the second frequency band overlaps with the first frequency band.

5. The apparatus of claim 4, wherein the second information further includes modulation information for the second UE.

6. The apparatus of claim 5, wherein the modulation information of the second UE includes a quadrature amplitude modulation (QAM) order.

7. The apparatus of claim 4, wherein to perform the FDRSB impairment correction process on the signal, the at least one processor is configured to:
estimate, based on the second information, an FDRSB impairment of the second UE on the first frequency band; and
correct the FDRSB impairment of the second UE on the signal.

8. The apparatus of claim 4, wherein the at least one processor is further configured to:
receive, from the network entity, a second indication for a cease of an interference on the first frequency band by the second UE; and
refrain from performing, in response to the second indication, the FDRSB impairment correction process on the signal.

9. The apparatus of claim 1, wherein to perform the FDRSB impairment correction process on the signal, the at least one processor is configured to:
perform, based on an operational condition being met, the FDRSB impairment correction process on the signal.

10. The apparatus of claim 9, wherein the operational condition includes a battery level of the first UE is higher than a power threshold.

11. The apparatus of claim 1, wherein the at least one processor is further configured to:
transmit, to the network entity in response to an operational condition not being met, a third indication for an omission of the second information.

12. The apparatus of claim 11, wherein the at least one processor is further configured to:
calculate a noise level without the FDRSB impairment correction process on the signal; and
transmit, to the network entity, a fourth indication for the noise level.

13. The apparatus of claim 1, wherein the pilot signal includes a demodulation reference signal (DMRS).

14. An apparatus for wireless communication at a network entity, comprising:
at least one memory; and
at least one processor coupled to the at least one memory and, based at least in part on information stored in the at least one memory, the at least one processor is configured to:
receive, from a first user equipment (UE), first information for a frequency dependent residual side band (FDRSB) estimation and correction on the first UE;
transmit, to the first UE based on the first information, second information for a pilot signal of a second UE, wherein the first UE is frequency domain multiplexed (FDMed) with the second UE, and wherein a first frequency band of the first UE partially overlaps with a mirror frequency band of a second frequency band of the second UE with respect to a carrier frequency; and
communicate with the first UE based on an FDRSB impairment correction process using the second information.

15. The apparatus of claim 14, further comprising a transceiver coupled to the at least one processor, wherein to receive the first information, the at least one processor is configured to receive the first information via the transceiver, and wherein the at least one processor is further configured to:
transmit, to the first UE, a capability inquiry for a capability of the first UE for a performance of the FDRSB estimation and correction on the first UE, and wherein a reception of the first information for the FDRSB estimation and correction is based on the capability inquiry.

16. The apparatus of claim 15, wherein the at least one processor is further configured to:
evaluate an FDRSB distortion level with respect to an operated modulation and coding scheme (MCS) to obtain an evaluation result, and wherein to transmit the capability inquiry, the at least one processor is configured to:
transmit, in response to the evaluation result indicating the FDRSB impairment correction process is applicable, the capability inquiry.

17. The apparatus of claim 15, wherein the second information includes the pilot signal of the second UE on a portion of the second frequency band, wherein a corresponding portion of the mirror frequency band for the portion of the second frequency band overlaps with the first frequency band.

18. The apparatus of claim 17, wherein the second information further includes modulation information for the second UE, wherein the modulation information of the second UE includes a quadrature amplitude modulation (QAM) order.

19. The apparatus of claim 17, wherein the at least one processor is further configured to:
transmit, to the first UE, a second indication for a cease of an interference of the first frequency band by the second UE based on the second UE stopping its occupation of the second frequency band.

20. A method of wireless communication at a first user equipment (UE), comprising:
transmitting, to a network entity, first information for a frequency dependent residual side band (FDRSB) estimation and correction on the first UE;
receiving, from the network entity based on the first information, second information for a pilot signal of a second UE, wherein the first UE is frequency domain multiplexed (FDMed) with the second UE, and wherein a first frequency band of the first UE partially overlaps with a mirror frequency band of a second frequency band of the second UE with respect to a carrier frequency; and
performing, based on the second information, an FDRSB impairment correction process on a signal.
